(19) United States
(12) Patent Application Publication
(10) Pub. No.: US 2014/0089310 A1
(43) Pub. Date: Mar. 27, 2014

(54) PRODUCT CLUSTER REPOSITORY AND INTERFACE: METHOD AND APPARATUS

(71) Applicant: BBY SOLUTIONS, INC., Richfield, MN (US)

(72) Inventor: Jay Myers, Crystal, MN (US)

(73) Assignee: BBY SOLUTIONS, INC., Richfield, MN (US)

(21) Appl. No.: 13/626,289

(22) Filed: Sep. 25, 2012

(51) Int. Cl. G06F 17/30

(52) U.S. Cl. CPC G06F 17/3071
USPC 707/737

(57) ABSTRACT

The present invention is a method and apparatus for conducting transactions regarding similarity of products against a repository in which products are grouped in clusters according to their characteristics. A product suite repository interface facilitates such transactions. Such a repository is useful for consumers and participants in the supply chain. For example, a supplier could determine which products in its own offerings are related to those offered by a retailer. Partners in some effort might merge their offerings into a single catalog. A consumer might use the repository to find accessories that might enhance a purchased item.

### FIELD OF THE INVENTION

The present invention relates to suites of product information. More specifically, it relates to a repository and communication interface for information about clusters of products.

### SUMMARY OF THE INVENTION

Catalogs of products are maintained by retailers, suppliers, and manufacturers. For our purposes, it will be convenient to regard the word “products” as including goods, but it may also include services. The need to identify, or group together, related or similar products is important in a number of context. For example, closely related products might be organized, or displayed together, in a product catalog. A consumer that buys a particular type of product might also consider the purchase of a related product. A retailer might plan a product assortment using by starting with a few basic products, and then branching out to products that are either related to a basic product, or to other products already turned up by the relationship search. A supplier might do a relationship search of the products of a retailer to determine which of the supplier's offerings might be relevant to that customer.

A product repository, grouped into clusters of products is described. Access to the repository is through a product suite repository interface. Various transactions are implemented by the interface that facilitate operations like the kinds described above. For example, one might (1) ask for the clusters that include a product; (2) that clusters be formed from a set of products; that distances or similarities between products or clusters be calculated; that a new product be added to a product suite; that clusters be provided for the merger of two suites of objects; or that a search be conducted to determine which products in one suite are close to products or clusters in another suite.

A variety of clustering techniques are within the scope of the invention, including, among others, core-based clustering and hierarchical clustering. Core-based clustering, when appropriate, is simple and efficient. Diverse product assortments present a hurdle for defining a “distance”, but Jaccard distances can be used with tokenized string descriptions in such cases.

Note that we will sometimes refer to a “product” as being in a cluster or a repository, when strictly speaking, it is actually a representation of the product that is in the cluster or repository. Since this follows standard usage in the art, we expect that this should not cause confusion.

### BRIEF DESCRIPTION OF THE DRAWINGS

FIG. 1 is a block diagram of a system, representing embodiments of the invention, that shows information flows.

FIG. 2 is a block diagram showing a product suite repository having an interface through which cluster, product, and catalog information is requested, sent, and received.

FIG. 3a is a block diagram illustrating an information exchange occurring through a product suite repository interface, whereby the cluster that includes a product is requested, and that cluster is returned.

FIG. 3b is a block diagram illustrating an information exchange occurring through a product suite repository interface, whereby the specifications for a suite of products is received and a set of clusters for that suite is returned.

FIG. 3c is a block diagram illustrating an information exchange occurring through a product suite repository interface, whereby distance between two products or clusters of products is requested, and the distance is returned.

FIG. 3d is a block diagram illustrating an information exchange occurring through a product suite repository interface, whereby a product is added to the repository suite.

FIG. 3e is a block diagram illustrating an information exchange occurring through a product suite repository interface, whereby a set of clusters for an ancillary suite of products is received, and a set of clusters for the combination of the first suite with the repository suite is returned.

FIG. 3f is a block diagram illustrating an information exchange occurring through a product suite repository interface, whereby a set of clusters for an ancillary suite of products is received, and information is returned about products in the repository suite that are close to at least one product in the ancillary suite.

FIG. 4 is a conceptual diagram illustrating distances of several secondary products from a primary product.

FIG. 5 is a conceptual diagram illustrating a distance between two clusters of products.

FIG. 6 is a flowchart illustrating the creation of a cluster around a core product.

FIG. 7 is a flowchart illustrating a method for computing a distance between two clusters using product descriptors.

FIG. 8 is a flowchart illustrating cluster matching.

FIG. 9 is a flowchart illustrating product matching that might be used in constructing a cluster.

FIG. 10 is a flowchart illustrating the merger of two sets of clusters into a single set.

FIG. 11 is a flowchart illustrating creation of a product catalog using clustering, and transmitting that catalog through a product clustering communication interface.

FIG. 12 is a conceptual diagram illustrating product cluster tracing.

FIG. 13 is a flowchart illustrating product cluster tracing.

### DETAILED DESCRIPTION OF EXEMPLARY EMBODIMENTS

This description provides embodiments of the invention intended as exemplary applications. The reader of ordinary skill in the art will realize that the invention has broader scope than the particular examples described here.

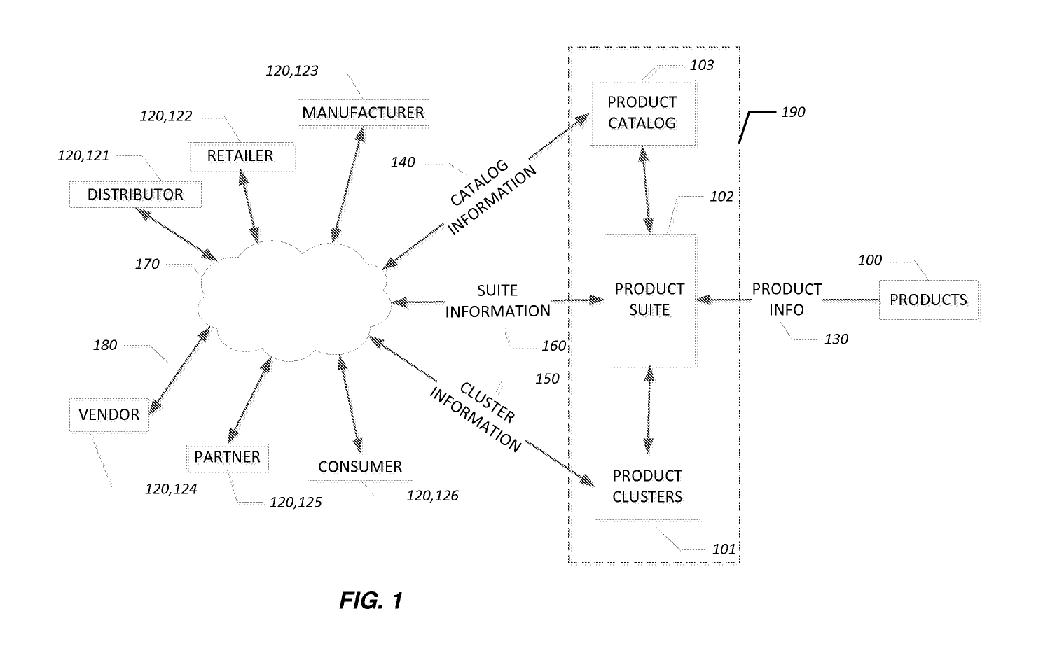

As illustrated by FIG. 1, a number of parties may be interested in a product catalog 103, or more generally, the strengths of relationships among sets of products 100. Such a party might be a consumer or an entity in the supply chain, such as a retailer 122, distributor 121, manufacturer 123, vendor 124, business partner 125. The terms “vendor” and “supplier” are sometimes distinguished. A vendor sells completed products 100 for resale, while a supplier sells raw materials or provides shared services to an organization. We will use “vendor” to represent both concepts. A business partner might be, for example, a parent corporation, a subsidiary, or an entity that collaborates on some venture.

More generally, we focus on anyone who might be interested in product suites 102 and their relationships to each other. We will refer to a person or entity interested in accessing information about a product suite 102 as an “associate”. We assume that information about a product suite 102 is contained in a product suite repository 190. While an associate 120 may be external to the organization(s) maintaining the repository 190, an associate 120 may also be internal to the organization(s), such as an employee or department.

A product 100 may be a tangible item, but might also be a service. A product model, or product type, is usually a template for instances or realizations of that product 100. For example, one might order an XYZ123 camera manufactured by company A (the model), and receive a particular XYZ123 camera (the product 100). Henceforth, when we refer to a, we will generally mean a product model/type unless it is clear otherwise from the context. A repository of information about a product suite 102 will contain product info 130 about the products 100. The product info 130 might contain characteristics such as an identification number, manufacturer, model number, dimensions, performance characteristics, and price.

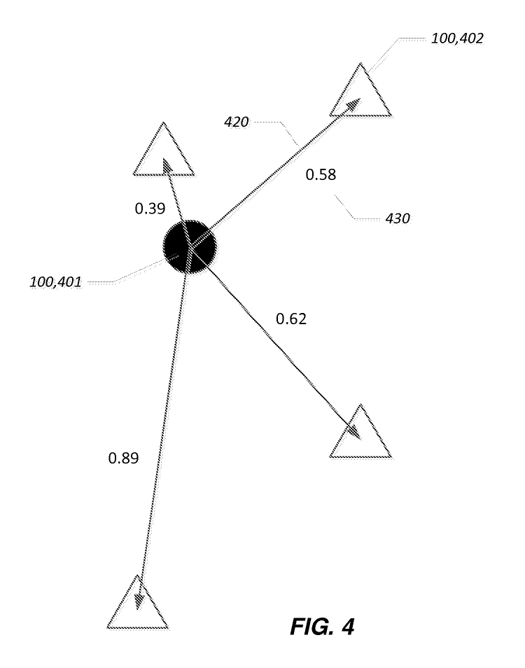

A product suite 102 may be organized into a product catalog 103, which may group products 100 in the products 100 into categories (e.g., home entertainment; or appliances). As described in more detail in connection with FIG. 4-6, the products 100 might also be grouped using more formal mathematical methods into product clusters 101.

Associates communicate with each other and with a product suite repository 190 using a communication system 170. A communication system 170 may enable remote or local communication, it might be wired or wireless, and may use any of the various types of hardware and transmission protocols and processes that are available. We use the term communication system 170 recursively. That is, any two connected communication systems 170 form a communication system 170. Such communication may facilitate transmission of requests for information or action, replies to such requests, and access to storage 230. By storage 230 we mean any type or system of tangible digital storage devices, whether volatile or long-term storage. Communication and information flows in FIG. 1 are shown by arrows typified by the one having reference number 180. In particular, associates may interact with a product suite repository 190 by sending or receiving suite information 160, cluster information 150, or catalog information 140. The repository I/F 200 sends and receives communications over some communication system 170, whereby associates 120 may interact with the repository 190.

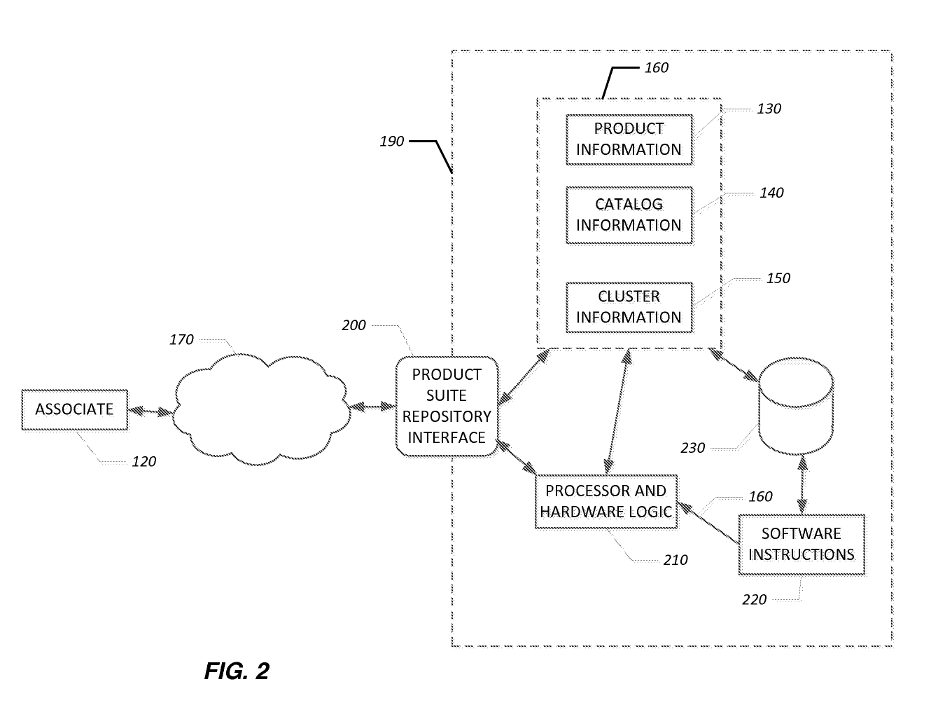

FIG. 2 illustrates a product suite repository 190. The repository 190 includes a processor 210, and may also include logic in hardware form. The repository 190 includes software instructions 220 that the processor 210 executes to maintain the repository 190 and manages and provides functionality for the repository 190 itself, and for a product suite repository I/F 200, through which information relating to the repository 190 is requested, sent, and received. The repository 190 includes suite information 160, which in turn includes product info 130, cluster information 150, and optionally catalog information 140. The suite information 160 and software instructions 220 may be saved in storage 230.

Note that the description in the previous paragraph is greatly simplified. There may be many computers, each possibly with a plurality processors, involved. The components may be local or dispersed. Storage may be in any number of forms, such as SSD, hard drives, memory, and tape, alone or a storage network under supervision of one or more controllers. The product suite repository I/F 200 may be a single hardware device, such as a port, a cable connection, or a wireless communication system; or it might be many of these acting in some combination. It might involve tangible controls, such as buttons or dials. It might involve a graphical user interface, with virtual controls. It might connect to any communication system 170, such as a local bus or the Internet. A product suite repository I/F 200 may even be dispersed over a plurality of locations, but in any case, it necessarily utilizes at least one hardware device.

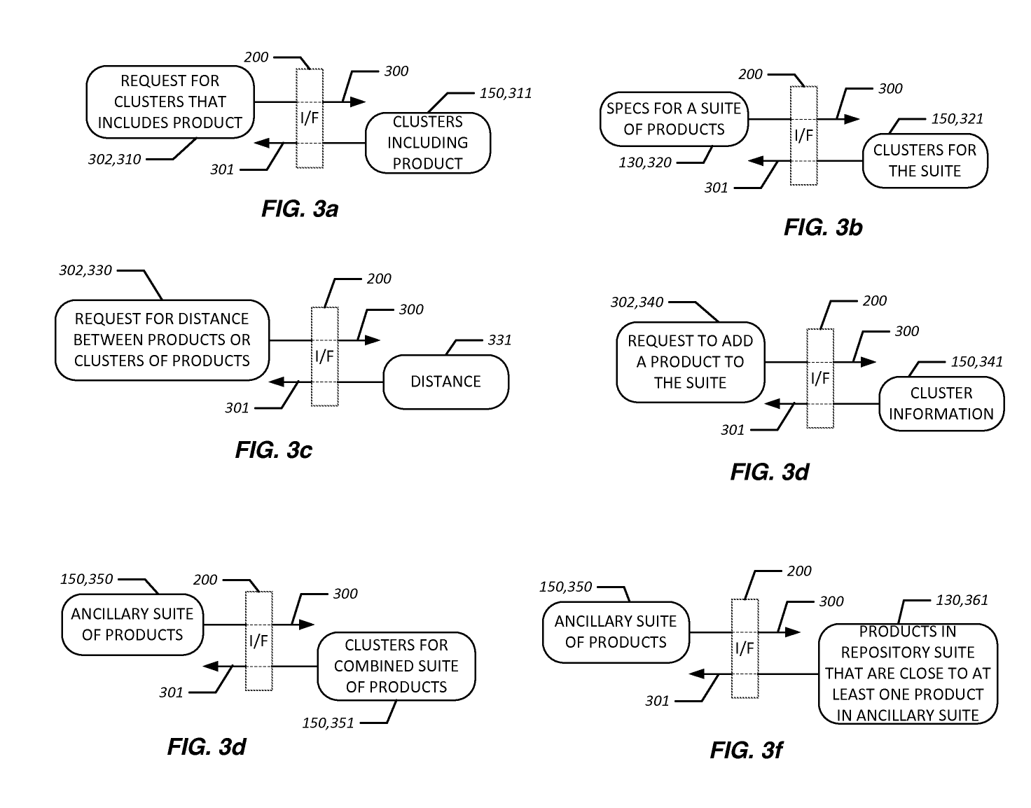

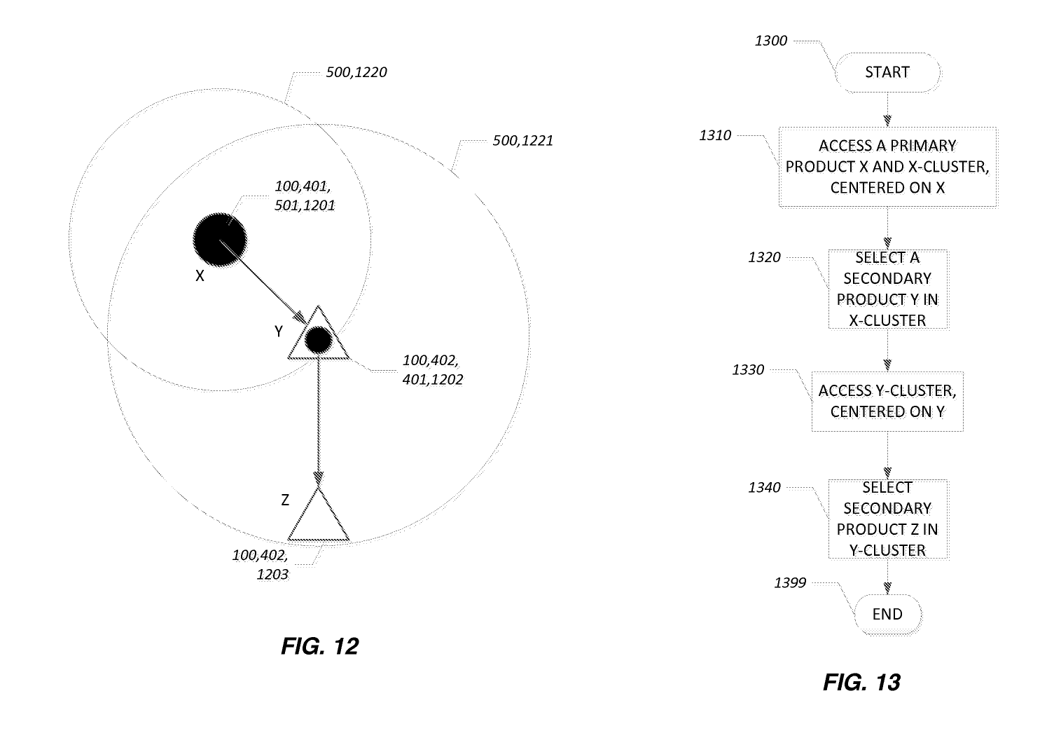

FIG. 3a-3f illustrate contents of some types of queries 300 against a product suite repository 190 that a product suite repository I/F 200 may transmit, and corresponding responses 301. These figures are illustrative, not by any means exhaustive of the kinds of transactions utilizing clusters 101 that may be conducted though a product suite repository I/F 200. The method of FIGS. 12 and 13, for example, is not shown here. Also, a transaction to delete a product from the suite is not shown, although such a transaction is within the scope of the invention.

A query 300 may include a request 302, such as a request 310 for cluster(s) that include a particular product 100. In FIG. 3a, it is assumed that the repository 190 includes a product suite 102 that is organized into clusters 101. The cluster information 150 returned 311 is information about the cluster 101 or clusters 101, if any, including product 100. For a given cluster 101, such information might include, for example, an identification code for the cluster 101, a list of products 100 in the cluster 101, a distance 430 of the product 100 from a core product 501, and/or a set of characteristics that represent or typify the cluster 101. Also, product info 130 about the particular product 100 might also be returned.

In FIG. 3b, product specifications 130 for a set of products 100 is input to the repository I/F 200. (Of course, this transaction might have been initiated by a preceding response 301.) Returned 321 is cluster information 150 regarding organization of the products 100 into clusters 101. This transaction might be used to initialize the cluster information 150 in the repository 190, or to organize the products 100 of an associate 120.

In FIG. 3c, the query 300 is a request 330 for distance between products 100 or clusters 101. The distance might be product-to-product, product-to-cluster, or cluster-to-cluster. The distance is returned 331.

In FIG. 3d, the query 300 is a request 340 to add a new product 100 to the suite 102. Information about the clusters 101 to which the product 100 was added is returned 341.

In FIG. 3e, the input 350 is a set of product specifications 130 for each product 100 in some product suite 102 that is ancillary to the product suite 102 of the repository 190. The ancillary suite might belong to some associate 120, and the illustrated transaction might provide their combined product offerings. The product suite 102 organized into clusters 101, including some cluster information 150, is sent through the repository I/F 200 in response 351.

In FIG. 3f, as in FIG. 3e, the input 350 is a set of product specifications 130 for each product 100 in some product suite 102 that is ancillary to the product suite 102 of the repository 190. Information about any products 100 in the repository suite 102 that are close to at least one product 100 in the ancillary suite 102 is returned 361.

An object, such as a product, may be represented by a set of coordinates along axes in n-dimensional space, where n is the number of dimensions required to characterize all objects in the space of objects under consideration. For example, a light bulb from a given manufacturer might be characterized by its power usage in watts. An assortment of bulbs from the manufacturer is one-dimensional, and a “distance” between two models of light bulb might be simply the difference in wattage.

As another example, consider the product suite 102 of a vendor of shipping cartons. A box might be characterized by three dimensions—length, width, and height. (Of course, this is a simplification, since even characterizing just box-shaped cartons might also involve specifying, for example, material type and strength, sealing characteristics, and manufacturer.) Several possible “distance” metrics come to mind—for example, volume; perimeter; sum of length, width, and height; and diagonal length.

For a simple product suite 102, a spreadsheet or matrix in which columns are characteristics and rows are products captures all the relevant information. A cell contains the value of a particular characteristic for a particular product. While such a matrix might be feasible for some classes of product (light bulbs or TVs), imagine the problem of putting all products 100 from a department store or a multinational e-commerce company into such a matrix. How can one define a distance between, say, a candy bar and a bottle of motor oil? Clearly, reducing such an assortment to a single matrix where distance 430 between rows makes sense seems unfeasible.

One approach is to characterize each product 100 by a set of strings or tokens that describe its purpose, operation, compatibility with other kinds of products, and other important features defining its properties. For example, a monitor might have descriptors such as: “TV and Home Theater TVs”, “HDMI Cables”, “LCD Flat-Panel”, “50 inch”, “1080p”, and “HDMI Inputs”. A cable might have the descriptors such as: “TV and Home Theater”, “TV and Home Theater Accessories”, “HDMI Cables”, “Type of Cable HDMI”, and “Cord Length 6 feet”. A descriptor of a product might be obtained from a manufacturer, a vendor, or from observation of the product 100 itself.

A string is a particular kind of token. Since product info 130 may come from diverse sources, a string might be subjected to a standardization process to improve determination of similarity between products. So, for example, the strings “Television”, “TVs”, “tv's”, and “TV” might all be standardized to a token string “TV” or to some identifier token, such as “x1234”, which is an alternative to a more descriptive string.

As mentioned before, for simple product suites 102 there may be some natural metric to determine the distance between two products 100 or the distance 430 between them, such as the volumes of cartons. For a tokenized product suite 102, there are a number of measures of similarity in the literature, including Jaccard similarity, Tanimoto similarity, Dice's coefficient, and the Tversky index. Conceptually, “distance” is large when “similarity” is low. The Jaccard similarity (S) is the magnitude of the intersection of two sample sets, divided by the magnitude of the union of the two sets. Thus, S=1 when a set is compared with itself, and S=0 when the set are entirely dissimilar. Jaccard distance is defined as 1−S. Some measures of similarity, like Jaccard, have distance counterparts, while others do not. Throughout this document we choose to use distance 430 to characterize relationships between products 100 in a product suite 102, but the use of similarity is equivalent, and within the scope of the invention. Henceforth, we assume that some measure of distance 430 (or similarity), Jaccard distance between tokenized product descriptors, has been chosen that allows any two given products 100 within a given business or other operational context to be compared. Distance and similarity methodologies that may be used in embodiments of the invention are discussed further below, under “Distance Measuring”.

In FIG. 4, one product 100 is regarded as a primary product 401 under consideration, and several others are regarded as secondary products 402. The figure illustrates distance 430 (e.g., Jaccard distance), shown for each secondary product 402 as a label (typified by one tagged with a reference number) on an arrow 420 from the primary product 401.

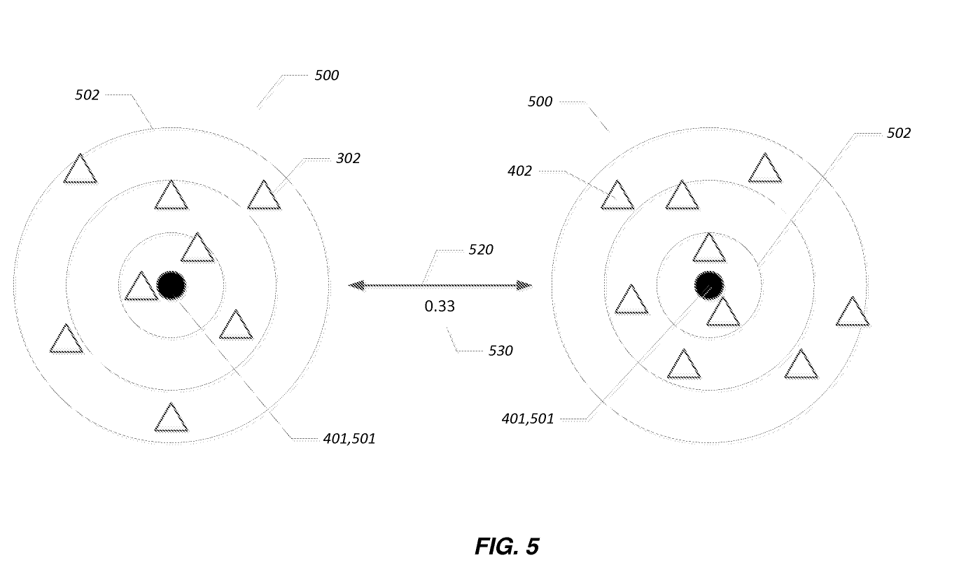

In a retail context, a core product 501 is typically a major purchase for which a consumer 126 buys peripheral devices and services. In consumer electronics, computers, televisions, cameras, and smart phones are examples of core products 501. FIG. 5 shows two clusters 101 that are each formed from sets products 100 that are within a certain cut-off distance 430 from their respective core product 501. Concentric circles 502, typified by one from cluster 101 labeled with a reference number, indicate distances 430 from the core 501 of the secondary products 402.

For this core-centric clustering scheme embodiment, the distances between pairs of secondary products 402 are irrelevant and unused. The scheme is appropriate for an operation for which core product 501 organization would be conducive. Note that the core need not be an actual product at all. In the tokenized descriptor approach, the core tokens might characterize a class or category of products, such as flat panel TVs generally, rather than “brand X-model Y”. Henceforth, the term core product 501 will include such a virtual core. The core-centric approach, when appropriate, also has the advantage of being computationally less intensive than a scheme in which all product-to-product distances are significant. Note also that in a core-centric approach, a product 100 might possibly be in more than one cluster 101.

Suppose, for example, that a product suite 102 include N products 100. For large N, if there are 20 core tokens, then there will be approximately 20N distances 430. But there will be approximately N̂2 pairs of products, where ‘̂’ indicates exponentiation. For N=100,000, the core approach has about 2*10̂6 distances, compared to 10̂10 pairs, a multiplicative difference of four orders of magnitude. Both approaches, core and pair-distance based, are within the scope of the invention.

FIG. 5 also depicts a cluster-cluster distance 530. For example, this might be the distance between the cores 501. Alternatively, a set of all token strings for all products 100 in each cluster 101 might be used to form a composite token string for that cluster 101, and a cluster-cluster distance formed from the two composites. In some contexts, an average, or center of gravity, representation of all the products 100 in each cluster 101 might be computed, and then Euclidean distance between used as the respective averages used.

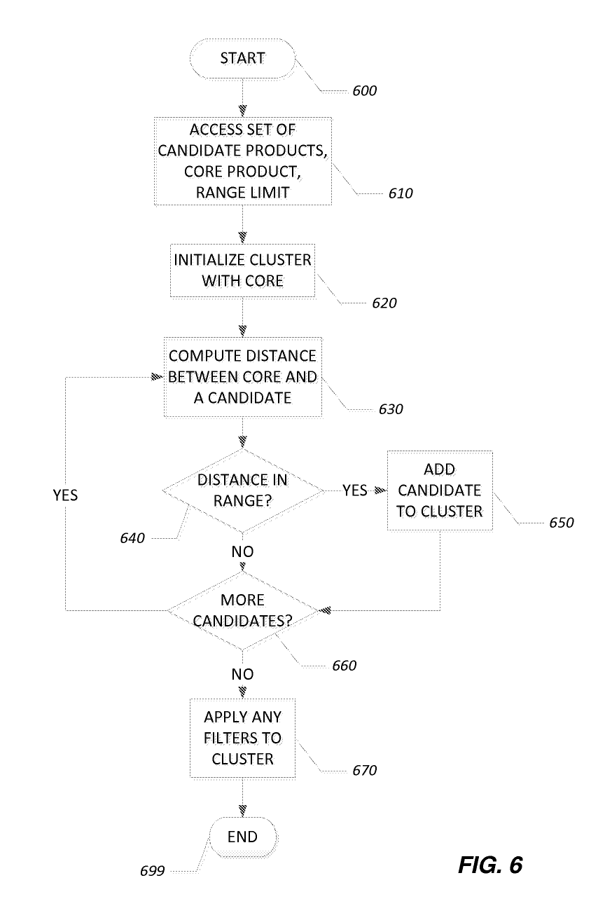

FIG. 6 is a flowchart illustrating a core-based process for clustering a set of products 100. After the 600, the core product 501, a set of candidate products 100 to be tested for inclusion in the cluster 101, and a range limit are accessed 610. The access might be, for example, from a product suite repository 190, through a repository I/F 200, from a database in storage 230, or through a user interface. The cluster 101 is initialized 620 with the core product 501. The distance 430 between a candidate secondary product 402 and the core product 501 is computed 630 according to whatever distance or similarity scheme is being used. If 640 the distance is within the range limit, then the candidate secondary product 402 is added 650 to the cluster 101. If 660 there are more candidates to consider, the process loops back. Step 670 introduces the concept of filters. Filters might be based on any type of factor, typically ones that are not already included in the descriptor of the product. For example, one might want to exclude all products 100 whose price exceeds a certain amount, or all red items. Of course, filtering might also be done within the loop. The process ends 699.

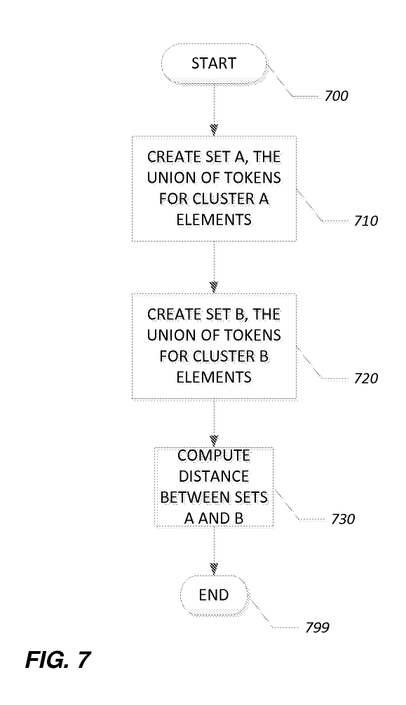

FIG. 7 illustrates a method for computation of a distance 530 between clusters 101, by concatenation, or set union, of the respective token representations of the products 100 in each of the two clusters 101. After the start 700, the union of the set of all tokens from the first cluster 101 is formed 710. The same is done 720 for the second cluster 101. The distance 530 is computed 730, and the process ends 799.

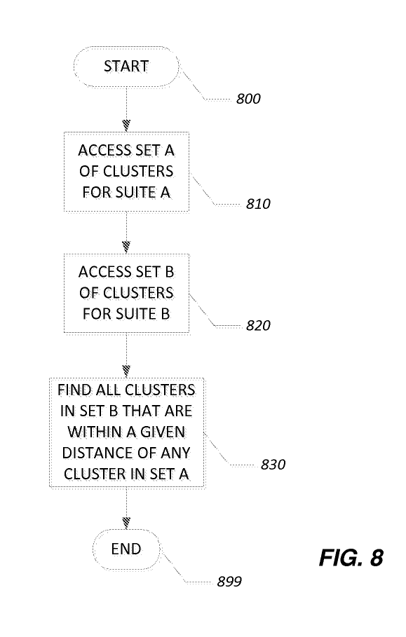

FIG. 8 illustrates a method for matching between two product suites 102 to find similar clusters 101. After the start 800, the set of clusters 101 from the first product suite 102 is accessed 810. Then the same is done 820 for the second product suite 102. All clusters 101 from the second suite 102 that are within a given distance 530 from any cluster 101 in the first suite 102 are found 830, and the process ends 899.

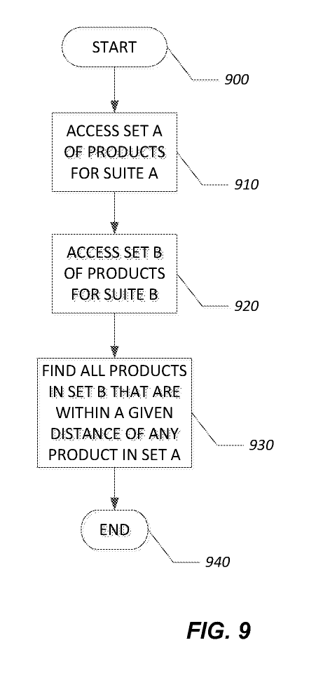

FIG. 9 illustrates a method for search for products 100 in a similar product suite 102. After the start 900, the set of products 100 from the first suite 102 is accessed 900. The same is done 920 for the second suite 102. All products 100 from the second suite 102 that are within a given distance 430 of any product in the first product suite 102 are identified 930, and the process ends 999. Note that in addition to the cluster-to-cluster search of FIG. 8 and the product-to-product search of FIG. 9, product-to-cluster matching (not shown) may also be performed.

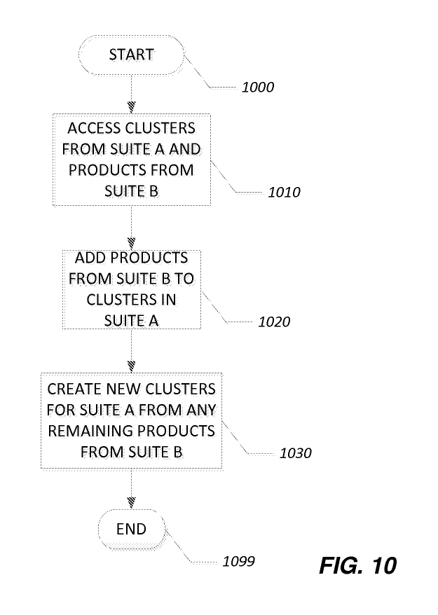

FIG. 10 illustrates a method for merger of two product suites 102. After the start 1000, clusters 101 from the first product suite 102 and products 100 from the second are accessed 1010. Any product 100 from B that is close to a given cluster 101 (or a product 100) from A, then the product 100 is added 1020 to that cluster 101. Some products 100 from B may not fit into existing clusters 101, from A, so new clusters 101 may be formed 1030. The process ends 1099.

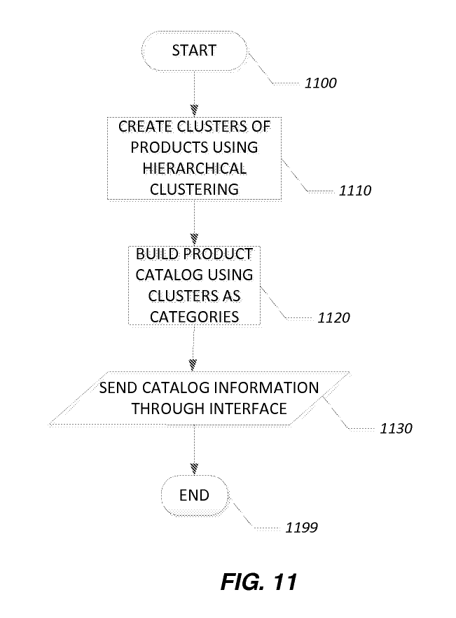

FIG. 11 illustrates the use of clustering to create a product catalog 103. After the start 1100, clusters 101 are created 1110. In this embodiment, a different method of forming clusters is used, hierarchical clustering. This technique is based on distance between pairs of products 100. Closest objects initialize clusters, which grow as further objects are gradually added as a threshold distance expands. A tree of associations forms as a result, with all objects being grouped together at the maximum object-to-object threshold. The tree may be “cut” at some smaller distance into more clusters 101. Indeed, there are many clustering techniques in the literature, all of which are available within the scope of the invention. The clusters 101 are used 1120 to form the basis for a product catalog 103. The catalog 103 is displayed 1130 through the product suite repository I/F 200, and the process ends 1199.

FIG. 12 is a conceptual diagram that illustrates how clusters 101 might be used to trace for related products. In the figure, two clusters 101, namely, X-cluster 1220 and Y-cluster 1221 are represented simply as circles. Each of these clusters 101 is assumed to include a set of products 100, which, for the sake of clarity, are not all shown explicitly. X-cluster 1220 is centered around product X 1201. X 1201 may be a core product 501. Y 1202 is a secondary product 402 in X-cluster 1220. Product Z 1203 is in Y-cluster 1221, centered around product Y 1202. (Note, as suggested by the figure, all clusters 101 may or may not have the same radius, that is, the same cut-off distance 430.)

In FIG. 12, a single product 100, namely Y 1202 is selected for further tracing from X-cluster 1220, and the tracing ends after two steps, namely, X-to-Y, and Y-to-Z. More generally, tracing starting at X 1201 may select a subset Q of the products 100 in X-cluster 1220. Tracing may continue from each product 100 in Q. Also, the tracing may stop after a single step, or continue on through any number of steps.

FIG. 13 presents the method of FIG. 12 as a flowchart. After the 1300, a primary, or a core, product X 1201 are accessed, along with a cluster, X-cluster 1220, centered around X 1201. Y 1202, a secondary product 402 in X-cluster 1220, is selected. Y-cluster 1221, centered around Y 1202 is accessed. Z 1203, a secondary product 402 in Y-cluster 1221, is selected. Note that steps 1320-1340 may be repeated for other secondary products 402 in X-cluster 1220. Also, further tracing might start from each of a set of secondary products 402, like Z 1203, selected from Y-cluster 1221, and so on, recursively.

The techniques described above may be also used to identify kinds of products that are not in an existing product suite. For example, suppose that a product X is identified that has no nearby neighbors. Then a retailer or supplier might research which existing products might be available to fill that gap; or a new product might be developed that has similarities to X, but with some improvements, or that serves needs that are identified as being associated with X.

### Distance Measuring

Results, techniques, and formulas from the following articles may be used to implement various aspects of some embodiments of the invention.

### Pandit et al.

Pandit, Shradda and Gupta, Suchita, “A Comparative Study On Distance Measuring Approaches for Clustering”. International Journal of Research in Computer Science 2.1, pp. 29-31 (2011), is hereby incorporated by reference in its entirety. This article examines many of the most popular algorithms used in data mining, clustering, and distance measuring. Of particular relevance to some embodiments of the invention are algorithms that pertain to distance measuring of strings and text, including Hamming Distance, Jaccard Index, Cosine Index, and Dice's coefficient.

The authors describe Hamming Distance as the number of bits that need to be changed to turn one string into another. Utilizing this methodology, Hamming measures the distance between strings by calculating the number of places where individual characters are different.

The Jaccard Index measures how similar two strings (objects) are by the size of their intersection divided by the size of the union.

The Cosine Index is used in text matching, often times in the comparison of documents for text processing. The algorithm yields several values; exactly the same, exactly opposite and a range of in-between values that indicate similarity or dissimilarity.

Dice's coefficient also measures string similarity, and is related to the Jaccard Index. In text and string similarity comparison, Dice's coefficient measures the frequency of sequences of two adjacent elements, known as bigrams.

### Cohen et al.

Cohen, William W. and Ravikumar, Pradeep, et al. “A Comparison of String Distance Metrics for Name-Matching Tasks”, in “Proceedings of IIWeb”, pp. 73-78 (2003), is hereby incorporated by reference in its entirety. This paper compares popular string distance algorithms, with a specific focus on the performance of Jaro-Winkler string distance scheme and it's variants, along with a weighting scheme called TFIDF (Term Frequency Inverse Document Frequency). Good results both in computational performance and accuracy have been achieved with Jaro-Winkler and TFIDF, performing somewhat better than if the two schemes were to work on their own. The authors conclude that Jaro-Winkler's primary use case is short strings.

### Navarro

Navarro, Gonzalo. “A Guided Tour to Approximate String Matching,” ACM Computing Surveys 33:1, pp. 31-88 (2001), is hereby incorporated by reference in its entirety. This article examines the concepts of approximate string matching and finding patterns in text. It looks at distance between strings, and brings to light the notion of edit distance, a model that allows insertion, deletion, and substitution of simple characters to determine the distance of two strings. String matching algorithms have many different applications; for the purposes of this invention, the most important data from this article revolves around text matching, string comparison, and text retrieval. Levenshtein distance has been at the heart of many string matching efforts. Early work centered on word spelling correction, and in more recent times the work has shifted toward the growing web of data. Levenshtein (also referred to as edit distance) is referred to as “the minimal number of insertions, deletions, and substitutions to make two search strings equal”. In addition to discussing pre-existing edit distance theories like Levenshtein, the article touches on the topic of filtering. Filtering in string and text matching generally means examining very large amounts of text and discarding parts that are not considered to be a match. The article goes on to examine patterns, and splits this area into two parts, moderate patterns and very long patterns. Moderate patterns can utilize more basic algorithms, while very long patterns often work by traversing large amounts of text and capturing shorter matching substring patterns which are then traversed again once the larger string or text has been fully searched. The paper concludes that older algorithms like Levenshtein are useful, but the better and more modern string distance and matching algorithms utilize advanced filtering techniques to discard irrelevant data and then apply distance algorithms on the result to check for matches.

### Winkler

Winkler, William E. “Overview of Record Linkage and Current Research Directions”. Bureau of the Census (2006), is hereby incorporated by reference in its entirety. This paper analyzes the concept of Record linkage (aka, “data cleaning” or “object identification”)—the methods of comparing data across data sets to determine if the data matches or has an association to a particular entity. For the purpose of this invention, these techniques would be helpful in determining relationships between groups of strings, i.e., the formation of product “clusters”, where like products are arranged around each other. Record linkage is good at matching entities that are similar based on sub-attributes, not the primary unique identifier of objects. While this study focuses on Census data that includes people and businesses with unique identifiers (name) and their sub identifiers (address, phone, other fields), this technique could be applied to the linkage of consumer products that also contain a primary attribute (product name) and sub-attributes (product details/traits). Record linkage relies on text standardization, approximate string comparison and string/text search mechanisms to create links between entities. The Jaro-Winkler comparator is examined in the research, and the paper reports that Jaro-Winkler often outperforms newer string comparison algorithms on large Census data applications. Jaro-Winkler also provides effective string comparison and edit distance functionality. The research touches on text standardization in relation to improving string matching and comparison. These methods are traditionally rule based. There may be commercial software available (with pre-defined rule sets) that would be used to pre-process data before Record linkage algorithms would be run against said data set.

### Manivannan and Srivatsa

Manivannan, R and Srivatsa, SK. “Semi Automatic Method for String Matching”. Information Technology Journal 10:1, pp. 195-200 (2011), is hereby incorporated by reference in its entirety. This paper outlines a number of different methods used to perform string matching. An important fundamental for some string matching algorithms is edit distance—this is defined as the distance between strings S and T and the cost of the best sequence to convert S to T. Levenshtein distance is a common example of edit distance. Levenshtein distance has numerous extensions and algorithms that are similar to it. Needlman-Wunch distance is mentioned as a similar distance measuring mechanism, with the difference being an additional variable that alters the output of the algorithm to account for the “cost of a gap”. Smith-Waterman distance is also mentioned in the research. Smith-Waterman has two parameters that distinguish it from other Levenshtein-like distance algorithms: one accounts for computational costs for substitutions, and one for gap costs. Other methods outside of those with similarities to Levenshtein distance are discussed. The Jaro metric is one that's examined in the text. Jaro is based off of the number and order of common characters between two strings. As with other research, the authors conclude that Jaro and Jaro-Winkler are primarily intended for short string comparison.

Tanimoto similarity is generally known as an extension of the Jaccard coefficient. The difference is Tanimoto uses cosine similarity—measuring similarity between two vectors by finding the angle between them. This method is often used in applications that perform text mining.

TF/IDF (Term Frequency/Inverse Document Frequency) is also explored in the text. TF/IDF is used often in situations where term order is unimportant. In scenarios where TF/IDF is used, strings are tokenized and the individual tokens are analyzed for similarity, which commonly used along with weighting schemes in web search engines. The paper concludes that none of these methods on its own provides optimal string matching or distance measuring. The authors utilize a hybrid string matching approach using edit distance methodologies, domain-specific rules/dictionaries, and TF/IDF to achieve optimal results.

### Dorion and Guyard

Dorion, Eric and Guyard, Alexandre B. Measures of Similarity for Command and Control Situation Analysis. Collective C2 in Multinational Civil-Military Operations, June 2011, Quebec City, Quebec, Canada, is hereby incorporated by reference in its entirety.

This paper dives into the concepts of reasoning and similarity metrics, specifically within military “Command and Control” operations. These reasoning methods measure similarity of human experiences; how a situation is experienced once and then remembered again, and how that sort of reasoning can be duplicated in automated information systems. This has a correlation with the invention, as we are automating logical connections similar to how a human might, but on a larger and deeper scale.

Tversky's index is discussed as an alternative to other geometry-based algorithms (e.g., Jaro-Winkler, Tanimoto). Rather than focus on the distance between objects, the Tversky index uses the number of similar and dissimilar features between objects to determine similarity.

Hamming and Levenshtein distances are also discussed in the paper as a way to measure distances between structures. Both are considered edit distance measures. Hamming returns the number of symbols that are different between two sequences of equal length. Levenshtein distance yields the minimum number of edit operations (delete, insert and substitute) needed to morph a sequence into the other one.

### CONCLUSION

Of course, many variations of the above method are possible within the scope of the invention. For example, steps in a flowchart might equivalently be performed in a different order, and in a given embodiment, some steps might be eliminated, or others added. The present invention is, therefore, not limited to all the above details, as modifications and variations may be made without departing from the intent or scope of the invention. Consequently, the invention should be limited only by the following claims and equivalent constructions.

What is claimed is:

1. A system, comprising:
a) a product suite repository that stores product cluster information, wherein cluster analysis performed by a processing system on product information that describes individual products is used in creating the cluster information;
b) an interface to the product suite repository, the interface receiving an external request regarding the cluster information from a communication system, and transmitting from the repository over a communication system a response to the request.

2. The system of claim 1, wherein the request identifies a product, and the response identifies all clusters represented in the repository that include the product.

3. The system of claim 1, wherein the request includes product information about a suite of products, and the response includes information regarding a set of clusters that group the products.

4. The system of claim 3, wherein the set is used to initialize the cluster information in the repository.

5. The system of claim 1, wherein the request identifies a product, and the response includes a distance or similarity between the first product and a product represented in the repository, or between the first product and a cluster represented in the repository.

6. The system of claim 1, wherein the request identifies a product, and the response includes information regarding a cluster in the repository after a representation of the product has been added to repository.

7. The system of claim 1, wherein the request includes a representation of a first set of clusters, and the response includes information regarding the set of clusters in the repository after the first set of clusters has been added.

8. The system of claim 1, wherein the request includes a representation of a first product suite, and the response includes information identifying products represented in the repository that are within a specified distance or similarity range of at least one product in the first product suite.

9. The system of claim 1, wherein the cluster analysis uses distances or similarities between product descriptors, wherein the product descriptors each include a set of tokens or strings.

10. The system of claim 9, wherein the distances or similarities are, respectively, Jaccard distances or Jaccard similarities.

11. The system of claim 1, wherein two clusters in the repository contain the same product.

12. The system of claim 1, wherein a clusters in the repository are formed around a set of cluster cores.

13. The system of claim 14, wherein a cluster core is a virtual product.

14. The system of claim 1, wherein a product represented in the repository is a service.

15. The system of claim 1, wherein the cluster analysis uses hierarchical clustering.

16. An apparatus, comprising:
a) a processor;
b) tangible storage, including
(i) representations of a set of product clusters, which satisfy the conditions that
(A) each product cluster is centered around a respective core representation,
(B) each product has a representation that includes a set of tokens or strings, and
(C) distances or similarities between the respective representations of products are used to determine cluster membership of the products;
(ii) software instructions used by the processor to manage transactions affecting cluster membership.

17. The apparatus of claim 16, further comprising:
c) an interface including a hardware component which receives an external request that affects membership of a cluster in the set, and responds with information relating to the change in membership.

18. A method, comprising:
a) for each product in a set of products, storing in tangible storage a representation of the product as a set of tokens or strings;
b) accessing a set of core product representations;
c) accessing a range, which includes a cut-off value, for a measure of similarity or distance between product representations;
d) based on the measure and the range, and using a digital processing system, organizing the product representations into a set of clusters, each cluster centered on a respective core product representation.

19. The method of claim 18, wherein a core product is a virtual product.

20. The method of claim 18, wherein the measure is Jaccard distance or Jaccard similarity.

21. The method of claim 18, wherein a given product is represented in two clusters.

22. A method, comprising:
a) from a product suite repository, accessing, using a processor, a primary cluster of products, the primary cluster being centered around a primary product;
b) selecting a nonempty set of secondary products from within the primary cluster; and
c) for each secondary product in the nonempty set of secondary products,
(i) accessing a secondary cluster of products, the secondary cluster being centered on the secondary product,
(ii) selecting a nonempty set of tertiary products from within the secondary cluster, and
(iii) transmitting through an interface an indicator of identity of each tertiary product.

23. The method of claim 22, further comprising:
d) identifying a type of product that is not in the list of tertiary products.
